(19) United States
(12) Patent Application Publication
(10) Pub. No.: US 2017/0240354 A1
(43) Pub. Date: Aug. 24, 2017

(54) METHOD OF MAKING A REFUSE BAG

(71) Applicant: Michael Stewart, Detroit, MI (US)

(72) Inventor: Michael Stewart, Detroit, MI (US)

(21) Appl. No.: 15/399,826

(22) Filed: Jan. 6, 2017

Related U.S. Application Data
(60) Provisional application No. 62/275,291, filed on Jan. 6, 2016.

(51) Int. Cl. B65F 1/14; B65F 1/00

(52) U.S. Cl. CPC B65F 1/14; B31B 29/60; B31B 45/00; B65F 1/0006; B31B 2221/05; B31B 2221/20; B65F 2250/105; B65F 2250/108; B65F 2250/106

(57) ABSTRACT

A bag for receiving refuse may comprise a bag body, the bag body including an inside surface, an outside surface, and a rim defining a mouth. The bag may further comprise a first strip of material disposed on the inside surface of the bag body proximate the rim. The bag has an integrated polymer liner layer and is formed of a pair of valley folds and a pair of mountain folds.

### CROSS-REFERENCE TO RELATED APPLICATIONS

This application claims the benefit of U.S. Provisional Application No. 62/275,291, filed on Jan. 6, 2016. The entire disclosure of the above application is incorporated herein by reference.

### FIELD

The present disclosure relates to a refuse bag and more particularly to a method of forming a refuse bag from a single sheet of material.

### BACKGROUND

This section provides background information related to the present disclosure which is not necessarily prior art.

Plastic trash bags have long been used to line trash receptacles. The trash bags encourage sanitary conditions by preventing the refuse from contacting the receptacle. Trash bags also provide a convenient way to remove trash from a receptacle for transport or disposal.

When trash bags are used to line a receptacle, they are most often folded around the rim of the receptacle. Thus, the upper portions of the bag are often visible on the upper part of the receptacle, which may be aesthetically unpleasant. A further problem associated with arranging trash bags around a receptacle rim is that a user often does not know how much of the trash bag should be folded over the rim. If too little bag is folded over the rim, the bag could slip off the rim and back into the receptacle when the bag receives refuse. If too much bag is folded over the rim, the full volume of the receptacle may not be utilized.

### SUMMARY

This section provides a general summary of the disclosure, and is not a comprehensive disclosure of its full scope or all of its features.

In one embodiment, the bag for receiving refuse may comprise a bag body, the bag body including an inside surface, an outside surface, and a rim defining a mouth. The bag may further comprise a first strip of material disposed on the inside surface of the bag body proximate the rim. The bag has an integrated polymer liner layer and is formed of a pair of valley folds and a pair of mountain folds.

In another embodiment, the bag may further comprise a front wall, a back wall, and a hem, the hem defining the rim. The hem may further define a passageway, which is at least partially enclosed. The hem may include a first opening and a second opening. The bag may comprise a reinforcement ring, which is disposed within the passageway. The reinforcement ring may be accessible via the first and second openings in the hem. The bag may also comprise a second strip of material disposed within the inside surface of the front wall of the bag proximate the rim. The second strip may include an inside surface, an outside surface, a top edge, a bottom edge, a first end, and a second end, wherein the outside surface faces the inside surface of the bag. The first strip may further include a first end and a second end.

In another embodiment, the bag may comprise a bag body, the bag body having an inside surface and an outside surface. The bag may comprise a rim, which defines a mouth. The bag may further comprise a hem that defines the rim. The hem may define a passageway, the passageway being at least partially enclosed. The bag is formed of a paper layer having two pair of valley folds and two pair of mountain folds.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a refuse bag according to the present teachings in an unfolded condition;

FIG. 2 represents a refuse bag is a partially folded condition;

FIG. 3 represents a top view of the refuse bag in a folded condition;

FIGS. 4a-4d and 5 represent an alternate bag assembly;

FIG. 6 represents an assembly configured to accept sticks;

FIGS. 7a-7b represent alternate coupling mechanism for the reinforcing rim; and FIGS. 8-9e represent a bag according to the present teachings.

Corresponding reference numerals indicate corresponding parts throughout the several views of the drawings.

### DETAILED DESCRIPTION

Example embodiments will now be described more fully with reference to the accompanying drawings.

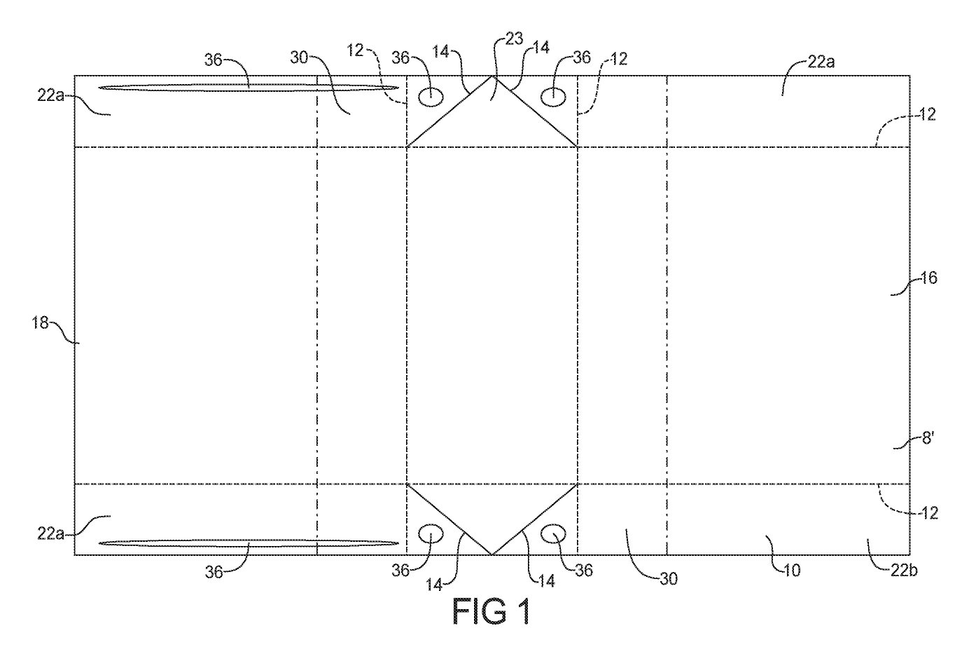

FIG. 1 represents a recyclable refuse bag according to the present teachings in an unfolded condition. Shown is a paper sheet 10. The bag 8 is formed using a plurality of valley folds 12 and a plurality of mountain folds 14. Generally, the valley folds 12 are used to separate the sheet into front 16 and back 18 portions. Coupled to the front and back portions 14 and 16, are four side members 22a-22d.

Associated with the sides 22a-22d are the pairs of mountain folds 16a-16d which intersect at a locus point 24 and form an associated triangular member 23. A polymer layer 30 con cover a portion 32 of the paper sheet 10. The polymer material can be a thermoplastic material that can act as an adhesive. In this regard, the polymer material can be a heat settable adhesive. Additionally, the polymer layer 30 can be biologically dissolvable and compostable material. Additionally hot glue 36 can be used to couple the sides 22a,b together and to couple and seal the triangle 23 to the sides 22a-d to form the bag 8.

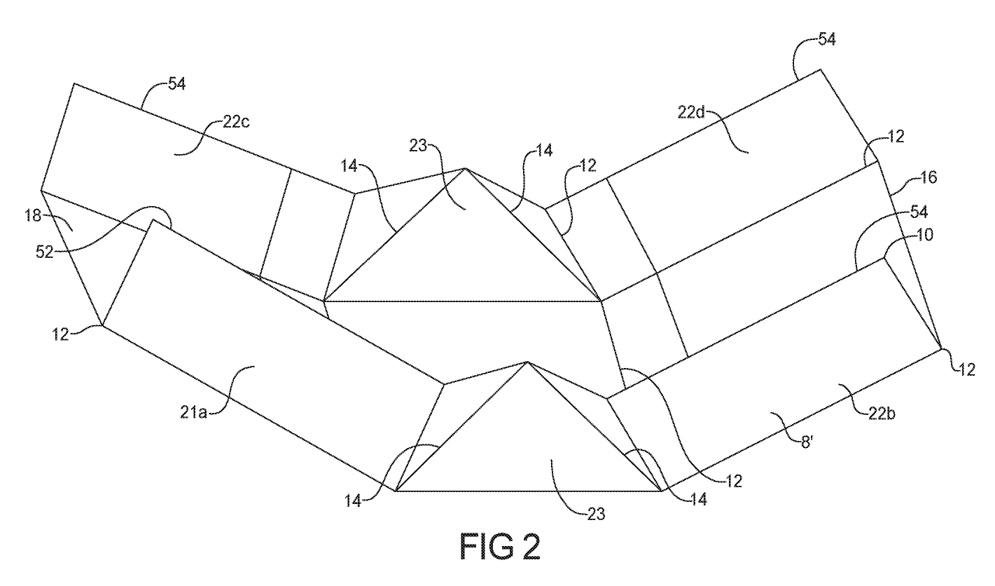

FIG. 2 represents a recyclable refuse bag is a partially folded condition. During the folding of the bag 8′ the front 16 and back 18 portions are brought together brining the sides 22a,b into contact with each other. When folded, the polymer layer 30 forms a water proof or tight portion or pocket. After folding, the adhesive can be used to form the structural bag. At this point, a polymer ring can be disposed about the opening or mouth of the bag. The ring is configured to apply pressure onto the bag and encourage the bag to open when the bag in unfolded.

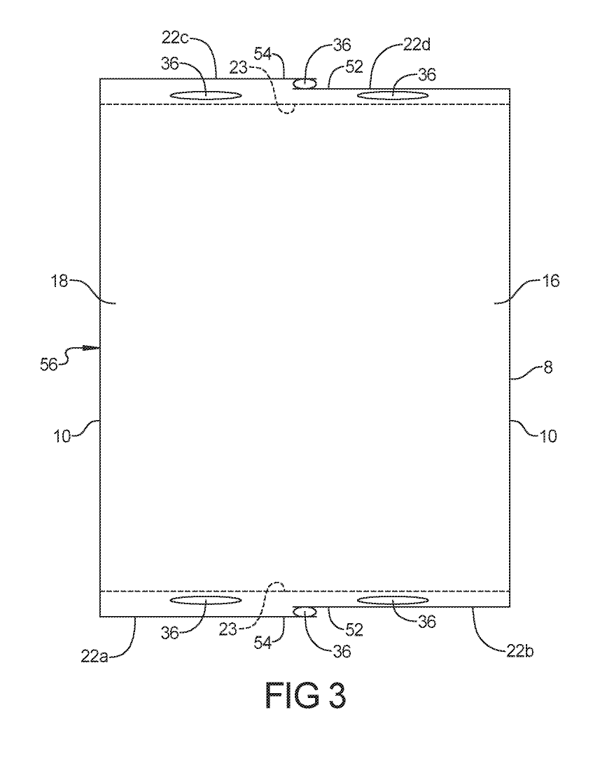

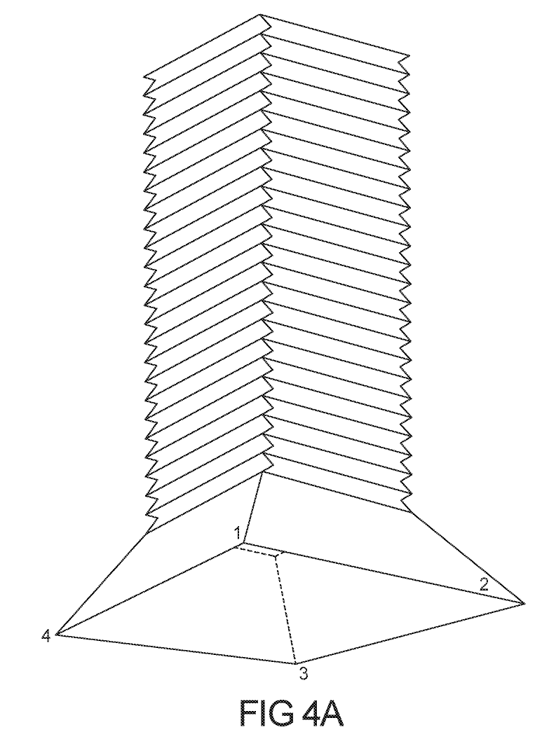

FIG. 3 represents a top view of the recyclable refuse bag in a folded condition. As see, the front 14 and back 16 are opposed on either side of a cavity formed by the paper 10. The sides 22a,b and 22c,d are also on opposed sides, and are fixably coupled at a valley fold to the front and back. Edges 52, 54 of the sides 22a,b and 22c,d are fixably couple by the adhesive. To complete the formation, the triangle members 23 are glued to the sides 22a,b and 22,c,d respectively. Optionally, the polymer ring 56 can be fastened to the interior cavity or exterior surface of the bag 8.

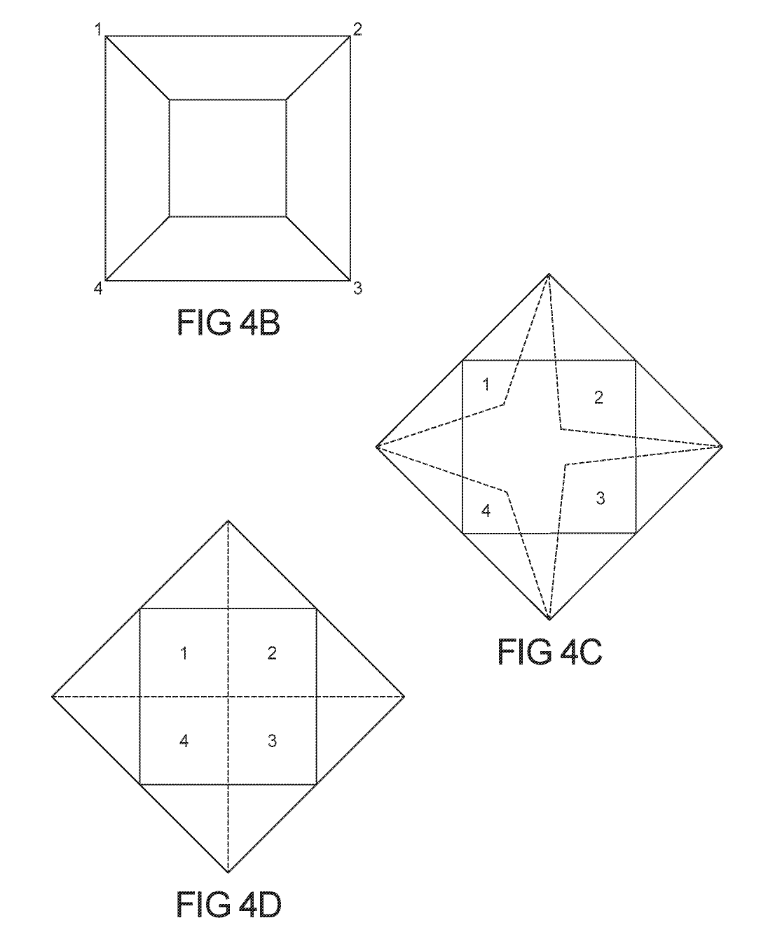

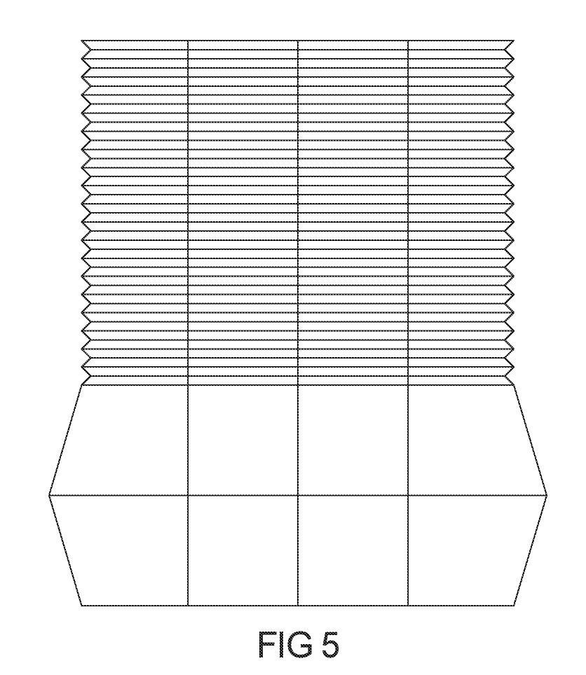

FIGS. 4a-4d and 5 represent an alternate bag assembly. The refuse bag is intended to be collapsible and expandible from a first configuration to a second configuration using an extendable bellows structure. As can be see, the top of the bag is open for refuse deposit. The bottom of the bag has an integral pyramidal structure that is configured to ace as a support structure for the bag. The pyramidal structure is intended to be filled with refuse to allow the base to support material being placed into the bellows structure. It is intended that when tension is applied to the bellows portion, it will remain in a semi-extended configuration. FIG. 4b represents a top view of the bag shown in FIG. 4a. FIG. 4c depicts folds that can be used to create the bottom. FIG. 5 represents a side view of the container in FIGS. 4a-5.

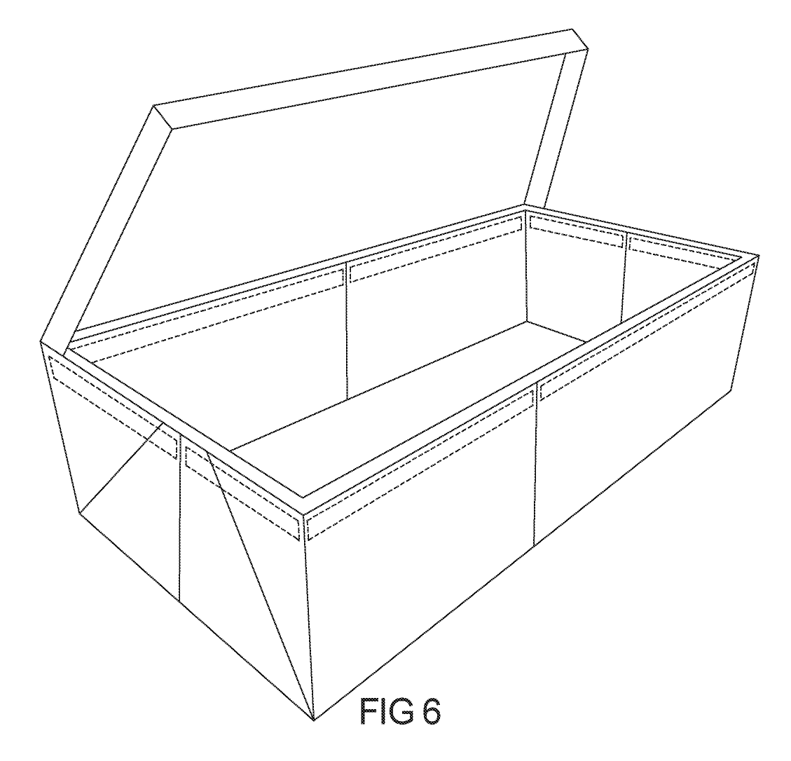

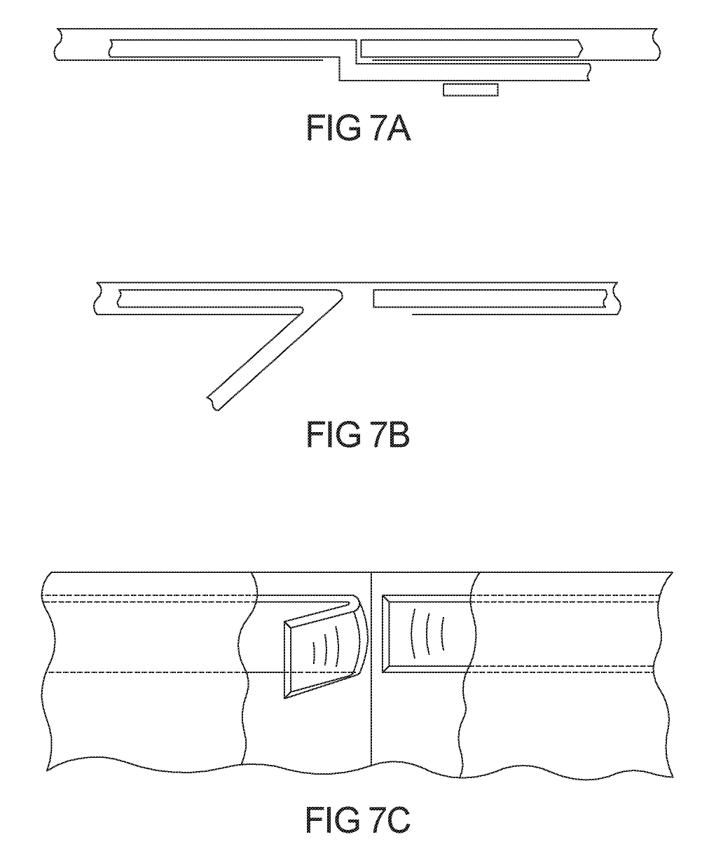

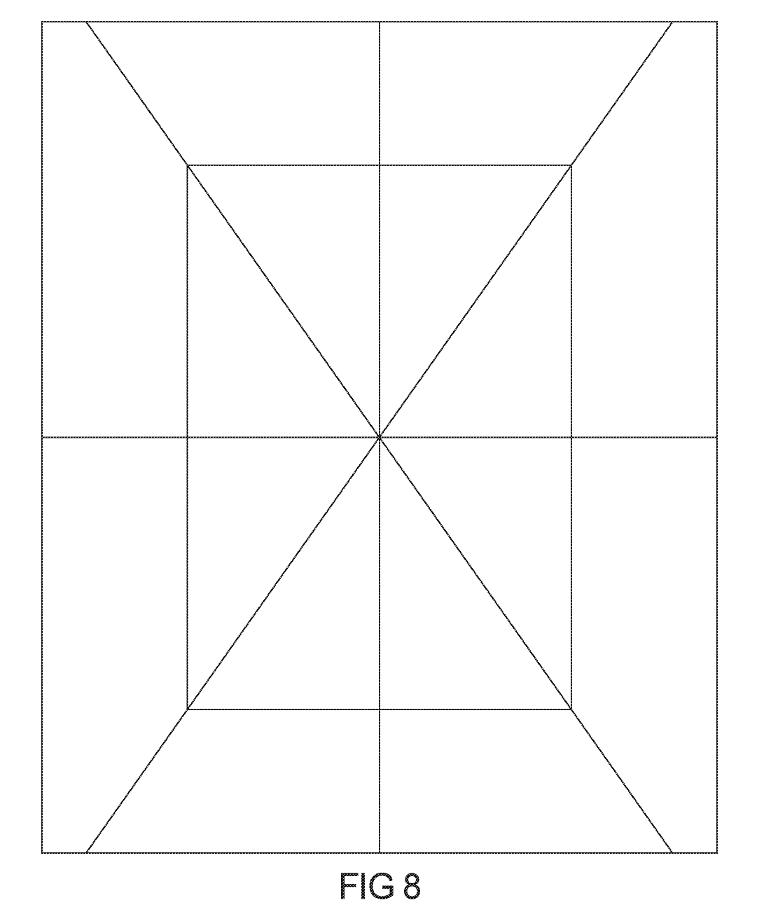

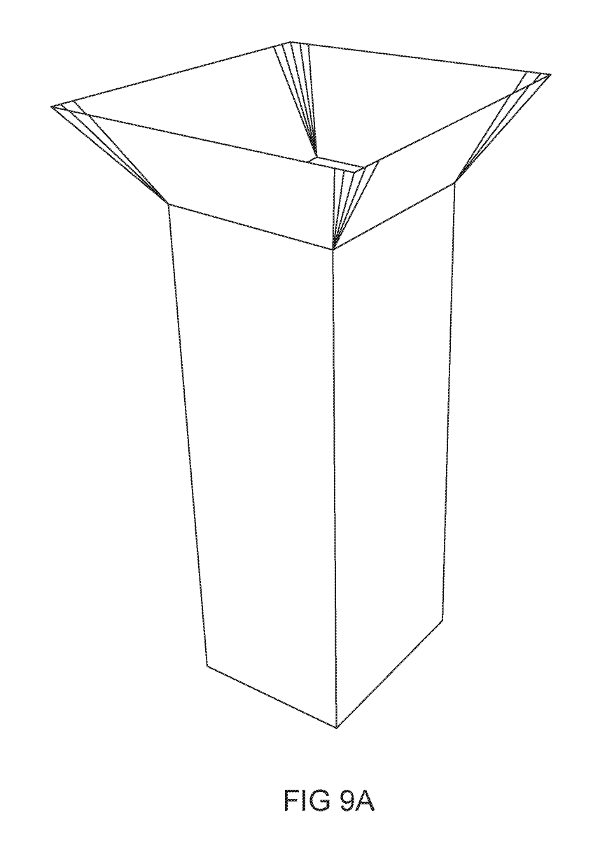

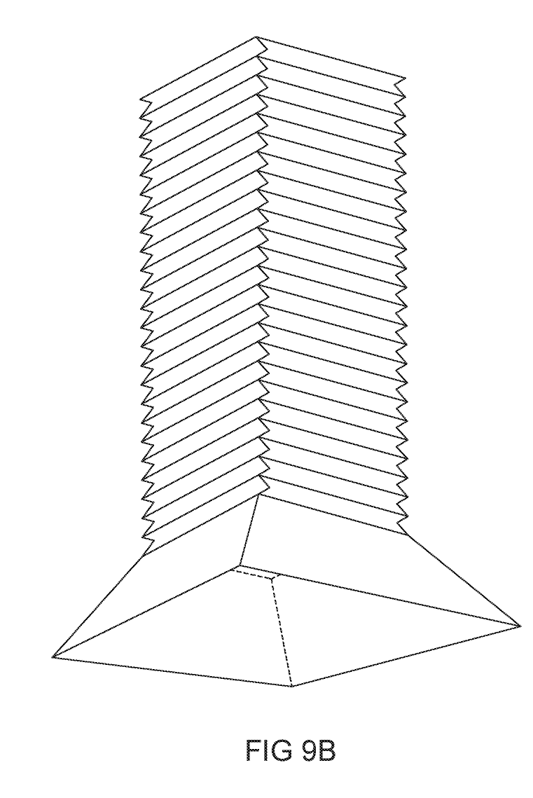

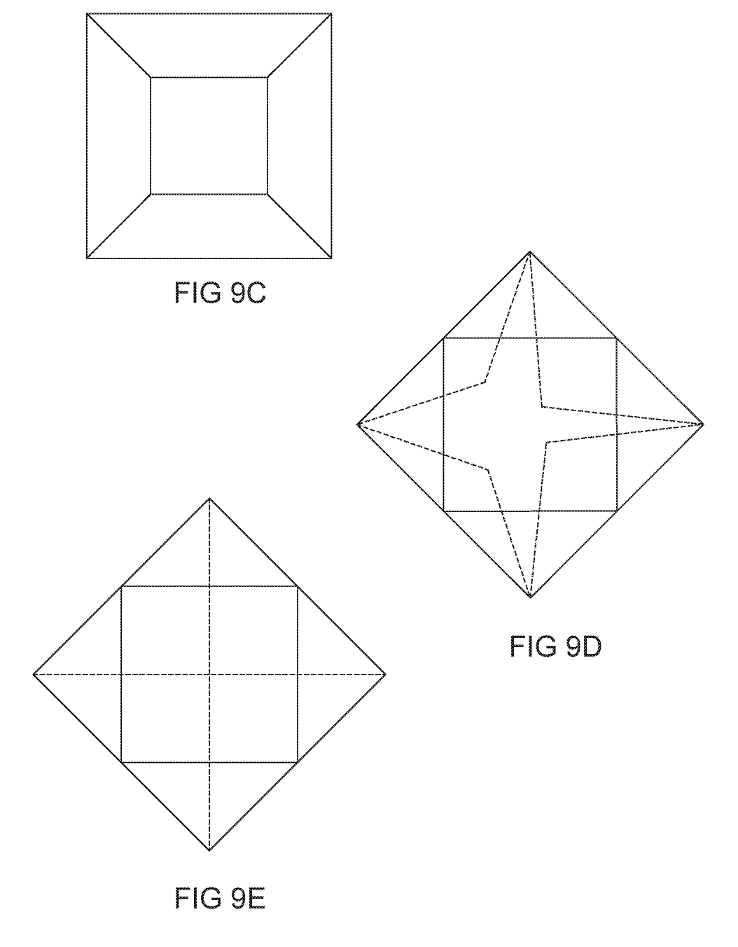

FIG. 6 represents an assembly configured to accept sticks. As shown in phantom, the perimeter of the opening can have a recyclable reinforcing rib formed of cardboard. At the locations of the fold points of the assembly, the rim is segmented. FIGS. 7a-7b represent alternate coupling mechanism for the reinforcing rim; and FIGS. 8 and 9 represent an alternate bag assembly. At each of the segments, the rim has an extendable tab portion. The tab portion extends from the cardboard or decomposable plastic rib that is surrounded by a fold around the recyclable member. The extendable tab portion can be passed through a slot formed in the paper bag material. The tab can then be placed into a loop formed of the recyclable bag material having an interference fit to hold the tab into position and add to rigidity of the rim.

As shown in FIG. 7C, the tabs can have shark fin gill shaped slits formed therein in a first direction which are configured to lock into shark fin gill shaped slits in an opposing direction on a second surface of one of the ribs. When placed under the loop, and slid in opposing directions, the locking slits engage each other and provide an adhesive free coupling that will provide support. It is envisioned this support structure can be used in any of the embodiments in this application.

The recyclable refuse bag can be formed of a paper sheet having a plurality of valley folds and a plurality of mountain folds. The valley folds forming a front portion, and back portion, coupled to the front and back portions, are four-side members, said paper defining an aperture. As described above, a plurality of integrated recyclable reinforcing members disposed about a periphery of the aperture, each reinforcing member having a first terminal end adjacent at least one of the plurality of valley folds and mountain folds. At least one of the reinforcing members defines a plurality of shaped slits configured to engage with a paper edge. The plurality of shaped slits configured to engage with a paper edge are one of crescent shaped and bracket shaped.

FIGS. 8-9e represent top and perspective side views of a refuse bag having an integral funnel portion. The funnel portion includes a plurality of folds that allow it to have a cross section similar to the rest of the bag in a folded condition.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A recyclable refuse bag comprising:
a paper sheet having a polymer layer disposed thereon the paper sheet having a plurality of valley folds and a plurality of mountain folds, the valley folds forming a front portion, and back portion, coupled to the front and back portions, are four side members, said paper defining an aperture;
a plurality of integrated recyclable reinforcing members disposed about a periphery of the aperture, each reinforcing member having a first terminal end adjacent at least one of the plurality of valley folds and mountain folds.

2. The recyclable refuse bag according to claim 1 wherein the reinforcing members are cardboard.

3. The recyclable refuse bag according to claim 2 wherein at least one of the reinforcing members defines a plurality of shaped slits configured to engage with a paper edge.

4. The recyclable refuse bag according to claim 3 wherein the plurality of shaped slits configured to engage with a paper edge are one of crescent shaped and bracket shaped.
